(19) United States
(12) Patent Application Publication
(10) Pub. No.: US 2011/0269864 A1
(43) Pub. Date: Nov. 3, 2011

(54) PRODUCING RESILIENT COMPRESSED FOAMED MATERIAL BASED ON MELAMINE-FORMALDEHYDE RESINS

(75) Inventors: Tobias Heinz STEINKE, Speyer (DE); Horst BAUMGARTL, Ludwigshafen (DE); Peter NESSEL, Ludwigshafen (DE); Klaus HAHN, Kirchheim (DE); Jens-Uwe SCHIERHOLZ, Bensheim (DE); Bettina WESTER, Maxdorf (DE); Christof MÖCK, Mannheim (DE); Bernhard VATH, Mannheim (DE); Denis Alfred GONZALES, Brussel (BE); Geert DE LEERSNYDER, Wielsbeke (BE)

(73) Assignee: BASF SE, Ludwigshafen (DE)

(21) Appl. No.: 13/097,371

(22) Filed: Apr. 29, 2011

Related U.S. Application Data
(60) Provisional application No. 61/329,105, filed on Apr. 29, 2010.

(51) Int. Cl. C08G 12/32; E04B 1/88; C08J 9/00

(52) U.S. Cl. 521/187

(57) ABSTRACT

The present invention relates to a process for producing resilient compressed foamed material based on melamine-formaldehyde resins, which comprises a melamine-formaldehyde precondensate being foamed and the soft, uncured melamine-formaldehyde foamed material being compressed and subsequently dried and optionally heat treated.

The present invention relates to a process for producing resilient compressed foamed material based on melamine-formaldehyde resins.

WO-A-2007/031944, EP-A-451 535, EP-A-111 860 and U.S. Pat. No. 6,608,118 disclose processes describing the subsequent compression of melamine-formaldehyde foamed materials.

However, these processes and these kinds of moldings leave something to be desired.

It is an object of the present invention to remedy the aforementioned disadvantages.

We have found that this object is achieved by a novel and improved process for producing resilient compressed foamed material based on melamine-formaldehyde resins, which comprises a melamine-formaldehyde precondensate being foamed and the soft, uncured melamine-formaldehyde foamed material being compressed and subsequently dried and optionally heat treated.

The process of the present invention can be carried out as follows:

The melamine resin foam can be formed at the boiling temperature of a blowing agent. The still soft, uncured melamine resin foam can subsequently be compressed by any method known to a person skilled in the art. Useful pressure-structures include for example rolls or rams. Subsequently, the melamine resin foam is dried and optionally heat treated.

The degree of compression may be optionally in the range from 1 to 90%, preferably 5 to 80%, more preferably 10 to 70% and more preferably 20 to 60% based on the original height (height of rise). Depending on the degree of compression, the densities of the resilient foamed materials are in the range from 5 to 100 g/l, preferably 10 to 50 g/l and more preferably 12 to 30 g/l.

These resilient compressed melamine resin foamed materials may preferably display an anisotropy, i.e., direction-dependent mechanics.

Production processes for melamine-formaldehyde resins and foams thereof are known from WO-A-01/94436 for example.

The foams and moldings of the present invention are obtainable as follows:
1. preparing a solution or dispersion comprising a precondensate of the foamed material to be produced and optionally further added components (Z),
2. foaming the precondensate by heating the solution or dispersion from step (1) to a temperature above the boiling point of the blowing agent to obtain a foamed material,
3. compressing the foamed material from step (2),
4. curing and drying the foamed material obtained in step (3).

The process of the present invention provides for in situ compression during foam production, i.e., compression without a subsequent process step.

The melamine-formaldehyde precondensates generally have a molar ratio of formaldehyde to melamine in the range from 5:1 to 1.3:1 and preferably in the range from 3.5:1 to 1.5:1.

These melamine-formaldehyde condensation products, in addition to melamine, may comprise up to 50% by weight, preferably up to 20% by weight, of other thermoset-resin formers and, in addition to formaldehyde, up to 50% by weight, preferably up to 20% by weight, of other aldehydes in cocondensed form. Preference is given to an unmodified melamine-formaldehyde condensation product, however.

Useful thermoset-resin formers include for example alkyl- and aryl-substituted melamine, urea, urethanes, carboxamides, dicyandiamide, guanidine, sulfurylamide, sulfonamides, aliphatic amines, glycols, phenol and its derivatives.

Useful aldehydes include for example acetaldehyde, trimethylolacetaldehyde, acrolein, benzaldehyde, furfural, glyoxal, glutaraldehyde, phthalaldehyde and terephthal-aldehyde. Further details concerning melamine-formaldehyde condensation products are found in Houben-Weyl, Methoden der organischen Chemie, volume 14/2, 1963, pages 319 to 402.

In a further preferred embodiment, the melamine-formaldehyde precondensate is present in the mixture in an amount from 55% to 85% by weight and preferably from 63% to 80% by weight.

Alcohols, for example methanol, ethanol or butanol, can be added in the course of the preparation of the melamine-formaldehyde precondensate in order to obtain partially or completely etherified condensates. The formation of ether groups can be used to influence the solubility of the melamine-formaldehyde precondensate and the mechanical properties of the completely cured material.

Anionic, cationic and nonionic surfactants and also mixtures thereof can be used as dispersant/emulsifier.

Useful anionic surfactants include for example diphenylene oxide sulfonates, alkane- and alkylbenzenesulfonates, alkylnaphthalenesulfonates, olefinsulfonates, alkyl ether sulfonates, fatty alcohol sulfates, ether sulfates, α-sulfo fatty acid esters, acylaminoalkanesulfonates, acyl isothionates, alkyl ether carboxylates, N-acylsarcosinates, alkyl and alkyl ether phosphates. Useful nonionic surfactants include alkylphenol polyglycol ethers, fatty alcohol polyglycol ethers, fatty acid polyglycol ethers, fatty acid alkanolamides, ethylene oxide-propylene oxide block copolymers, amine oxides, glycerol fatty acid esters, sorbitan esters and alkylpolyglycosides. Useful cationic emulsifiers include for example alkyltriammonium salts, alkylbenzyldimethylammonium salts and alkylpyridinium salts.

The dispersants/emulsifiers can be added in amounts from 0.2% to 5% by weight, based on the melamine-formaldehyde precondensate.

The dispersants/emulsifiers and/or protective colloids can in principle be added to the crude dispersion at any time, but they can also already be present in the solvent at the time the microcapsule dispersion is introduced.

As curatives it is possible to use acidic compounds which catalyze the further condensation of the melamine resin. The amount of these curatives is generally in the range from 0.01% to 20% by weight and preferably in the range from 0.05% to 5% by weight, all based on the precondensate. Useful acidic compounds include organic and inorganic acids, for example selected from the group consisting of hydrochloric acid, sulfuric acid, phosphoric acid, nitric acid, formic acid, acetic acid, oxalic acid, toluenesulfonic acids, amidosulfonic acids, acid anhydrides and mixtures thereof.

Depending on the choice of melamine-formaldehyde precondensate, the mixture comprises a blowing agent. The amount of blowing agent in the mixture generally depends on the desired density for the foam.

In principle, the process of the present invention can use both physical and chemical blowing agents (Encyclopedia of Polymer Science and Technology, Vol. I, 3rd ed., Additives, pages 203 to 218, 2003).

“Physical” or “chemical” blowing agents are suitable. “Physical” blowing agents herein are volatile liquids or compressed gases which acquire their blowing agent property through physical treatment (e.g., temperature, pressure). “Chemical” blowing agents herein are blowing agents which acquire their blowing agent property through chemical reaction or chemical decomposition with the release of gas.

Useful “physical” blowing agents include for example hydrocarbons, such as pentane, hexane, halogenated, more particularly chlorinated and/or fluorinated, hydrocarbons, for example methylene chloride, chloroform, trichloroethane, chlorofluorocarbons, hydrochlorofluorocarbons (HCFCs), alcohols, for example methanol, ethanol, n-propanol, isopropanol, ethers, ketones and esters, for example methyl formate, ethyl formate, methyl acetate or ethyl acetate, in liquid form or air, nitrogen or carbon dioxide as gases.

Useful “chemical” blowing agents include for example isocyanates mixed with water, releasing carbon dioxide as active blowing agent. It is further possible to use carbonates and bicarbonates mixed with acids, in which case carbon dioxide is again produced. Also suitable are azo compounds, for example azodicarbonamide.

In a preferred embodiment of the invention, the mixture further comprises at least one blowing agent. This blowing agent is present in the mixture in an amount of 0.5% to 60% by weight, preferably 1% to 40% by weight and more preferably 1.5% to 30% by weight, based on the melamine-formaldehyde precondensate. It is preferable to add a physical blowing agent having a boiling point between 0 and 80° C.

In a further embodiment, in addition to the melamine-formaldehyde precondensate of the foam to be produced, the mixture also comprises an emulsifier and also optionally a curative and optionally a blowing agent.

In a further embodiment, the mixture is free of further added substances. However, for some purposes it can be advantageous to add from 0.1% to 20% by weight, preferably from 0.1% to 10% by weight, based on the melamine-formaldehyde precondensate, of customary added substances, such as dyes, flame retardants, UV stabilizers, agents for reducing the toxicity of fire gases or for promoting carbonization.

It is also possible to add substances to the melamine-formaldehyde precondensate. In one embodiment, the foams comprise at least one added substance from the group consisting of dyes, scents, optical brighteners, UV absorbers, flame retardants and pigments. This added substance preferably forms a homogeneous distribution in the foam.

Useful pigments include the common inorganic natural pigments (chalk for example) or synthetic pigments (titanium oxides for example), but also organic pigments.

Useful flame retardant additives include for example intumescents, alkali metal silicates, melamine, melamine polyphosphate, melamine cyanurate, aluminum hydroxide, magnesium hydroxide, ammonium polyphosphates, organic phosphates or else flame-retardant halogen compounds. Similarly useful as additives are plasticizers, nucleators, IR absorbers such as carbon black and graphite, aluminum oxide powder or Al(OH)₃, soluble and insoluble dyes, biocidally active substances (such as fungicides) and pigments.

Process step (2) comprises heating to foam up the precondensate and, if present, the carrier material. By heating the solution or dispersion from step (1) to a temperature above the boiling point of the blowing agent used it is possible to obtain a foamed material. The precise temperature to be used is also dependent on the blowing agent used (on its boiling point for example). The heating in step (2) can be effected, for example, through the use of hot gases (such as air or inert gases) and/or high-frequency irradiation (microwaves for example).

The introduction of energy may preferably be effected via electromagnetic radiation, for example via high-frequency radiation at 5 to 400 kW, preferably 5 to 200 kW and more preferably 9 to 120 kW per kilogram of the mixture used in a frequency range from 0.2 to 100 GHz, preferably 0.5 to 10 GHz. Magnetrons are a useful source of dielectric radiation, and one magnetron can be used or two or more magnetrons at the same time.

Compressing the foamable melamine-formaldehyde resin can be effected by any method known to a person skilled in the art. Useful pressure-conferring structures include for example rolls or rams.

In a preferred embodiment, the compressed melamine-formaldehyde resin foam may preferably be produced batchwise.

For this, the flexible, as yet uncured melamine-formaldehyde resin foam obtained from step (2) can be compressed to the desired density in a foam box with variable pressure settings with the aid of a ram and with or without any filling body (to fix the density).

In a further preferred embodiment, the compressing of the melamine-formaldehyde resin foam may preferably be carried out in a continuous process, and so the previously foamed melamine resin is compressed directly.

For this, the flexible, as yet uncured melamine-formaldehyde resin foam obtained from step (2) can be for example compressed by means of a roll secured to the upper surface of the foaming channel. Alternatively, two or more consecutive rolls, twin belts or calendars are also possible. Similarly, compressing from the upper surface can be combined with compressing from the sides and/or from the lower surface of the foamed channel.

The foamed materials produced are finally dried to remove residual water and blowing agent from the foamed material.

The properties of the melamine-formaldehyde resin foam produced result from the foamable melamine-formaldehyde resin used and the overall density set for the support material.

The melamine resin foams of the present invention find application in the cushioning of seat areas, as heat, cold and/or sound protection or insulation/encapsulation of buildings and parts of buildings, more particularly walls, separations, roofs, exteriors, doors, ceilings and floors, of vehicles of any kind on land, on water, in the air and in space, whether for transporting cargo or people, or any such combination in passenger cars, trucks, for example for encapsulating the engine space (such as engine cowlings) or passenger cells, in rail traffic in the rail cars in goods or people transportation and also in locomotives, in aircraft, for example in the cabin interior, the cockpit or in the cargo space, and also in aerospace in manned or unmanned flying objects such as spaceships and space gliders, space capsules or satellites, for low-temperature insulation for example of cooling assemblies, refrigerators, cool houses, tank systems and containers for any desired liquids, more particularly for oil and gas or liquid gas down to −278° C., for storage and in transportation, for absorption and completely or partially reversible release of liquids down to −278° C. as “sponge”, in the cleaning industry for in the cleaning of surfaces for example in the form of sponges or saturated with cleaning agents of any kind inter alia for washing operations in (fully automatic) washing machines, as shock-dampening or shock-insulating packaging material, in hygiene applications (diapers, sanitary napkins) and also in the textile sector (apparel).

### EXAMPLES

### Inventive Example 1

75 parts by weight of a spray-dried melamine-formaldehyde precondensate (molar ratio 1:3) were dissolved in 25 parts by weight of water. This resin solution was admixed with 3% by weight of formic acid, 2% by weight of a sodium C₁₂/C₁₈-alkyl sulfate, 20% by weight of pentane, all based on the resin, stirred and subsequently foamed in a polypropylene mold (for foaming) by irradiation with microwave energy. The flexible foamed material is compressed with the aid of a polypropylene ram to half its original volume and dried for 30 minutes.

### Comparative Example A

75 parts by weight of a spray-dried melamine-formaldehyde precondensate (molar ratio 1:3) were dissolved in 25 parts by weight of water. This resin solution was admixed with 3% by weight of formic acid, 2% by weight of a sodium C₁₂/C₁₈-alkyl sulfate, 20% by weight of pentane, all based on the resin, stirred and subsequently foamed in a polypropylene mold (for foaming) by irradiation with microwave energy and dried for 30 minutes.

### Comparative Example B

### Similar to Example 1 of U.S. Pat. No. 6,608,118

75 parts by weight of a spray-dried melamine-formaldehyde precondensate (molar ratio 1:3) were dissolved in 25 parts by weight of water. This resin solution was admixed with 3% by weight of formic acid, 2% by weight of a sodium C₁₂/C₁₈-alkyl sulfate, 20% by weight of pentane, all based on the resin, stirred and subsequently foamed in a polypropylene mold (for foaming) by irradiation with microwave energy and dried for 30 minutes.

The starting materials produced according to Inventive Example 1 and Comparative Examples A and B were each used to produce a rectangular plate having the dimensions 200×200×40 mm compressed in an electrically heated and temperature-controlled hydraulic platen press in the direction of the shortest spatial coordinate at 270° C. and 4 bar for 3 min to half its original volume.

The results are collated in Table 1.

TABLE 1

| | | Ram | Tensile strength | Elongation at |
|---|---|---|---|---|
| | Density | pressure¹⁾ | [kPa], | break [%], |
| | [g/l] | [N/kN] | EN ISO 1798 | EN ISO 1798 |
| Inventive | 18.2 | | | |
| Example 1 | | | | |
| horizontal | | 57.2 | 176.7 | 21.8 |
| vertical | | 35.1 | 57.8 | 46.4 |
| Comparative | 8.9 | | | |
| Example A | | | | |
| horizontal | | 28.2 | 125.2 | 21.3 |
| vertical | | 26.7 | 123.6 | 22.5 |
| Comparative | 18.1 | | | |
| Example B | | | | |
| horizontal | | 43.2 | 143.9 | 14.7 |
| vertical²⁾ | | — | — | — |

¹⁾ram pressure values were in each case determined on the major surface of the test specimen
²⁾these values cannot be determined because of the geometry of the test specimen.

The melamine resin foam of Inventive Example 1 displays an anisotropy in respect of its mechanical properties.

The horizontal sections (orthogonally to the foaming direction and compressing) of Inventive Example 1 have distinctly higher ram pressure and tensile strength values compared with the uncompressed foam (Comparative Example A) and the subsequently compressed foam (Comparative Example B). Elongation at break is comparable to that of the uncompressed melamine resin foam.

The vertical sections (along the foaming direction and compression) of Inventive Example 1 display distinctly lower values compared with the horizontal sections of Inventive Example 1. By contrast, the elongation at break of the vertical section of Inventive Example 1 has more than doubled (46.4%) compared with the horizontal section of Inventive Example 1. By contrast, Comparative Example A displays almost isotropic characteristics in that there is scarcely any difference between the horizontal and the vertical section.

### Ram Pressure Measurement

To assess the mechanical quality of the melamine resin foamed materials a ram pressure measurement as described in U.S. Pat. No. 4,666,948 was carried out. A cylindrical ram having a diameter of 8 mm and a height of 10 cm was pressed into a cylindrical sample having a diameter of 11 cm and a height of 5 cm in the direction of foaming at an angle of 90° C. until the sample tears. The tearing force [N/kN] provides information as to the quality of the foamed material.

1.-7. (canceled)

8. A process for producing resilient compressed foamed material based on melamine-formaldehyde resins, which comprises a melamine-formaldehyde precondensate being foamed and the soft, uncured melamine-formaldehyde foamed material being compressed and subsequently dried and optionally heat treated.

9. The process for producing resilient compressed foamed material based on melamine-formaldehyde resins according to claim 8 wherein the soft, uncured melamine-formaldehyde foamed material is compressed to from 1 to 99% of the height of rise.

10. The process for producing resilient compressed foamed material based on melamine-formaldehyde resins according to claim 8 wherein the soft, uncured melamine-formaldehyde foamed material is compressed to from 5 to 80% of the height of rise.

11. The process for producing resilient compressed foamed material based on melamine-formaldehyde resins according to claim 8 wherein the density of the melamine-formaldehyde foamed materials is in the range from 10 to 100 g/l.

12. A cushioning for heat, cold and/or sound protection and for cleaning sponges comprising the foams and moldings according to claim 8.

13. A component of vehicle construction for passenger cars, trucks, coaches, agricultural and building machines, track vehicles and in the construction of aerospace vehicles comprising the foams and moldings according to claim 8.

14. A panel in vehicle construction for passenger cars, trucks, coaches, agricultural and building machines, track vehicles and in the construction of aerospace vehicles comprising foams and moldings according to claim 8.
